(19) United States
(12) Patent Application Publication
(10) Pub. No.: US 2003/0021545 A1
(43) Pub. Date: Jan. 30, 2003

(54) Connection of optical fibres to optical devices

(75) Inventors: Christopher James Hurr, Hampshire (GB); Darren Martin, Abingdon (GB)

Correspondence Address: FLESHNER & KIM, LLP, P.O. Box 221200, Chantilly, VA, 20153-1200, US

(73) Assignee: Bookham Technology plc

(21) Appl. No.: 10/200,208

(22) Filed: Jul. 23, 2002

(30) Foreign Application Priority Data
Jul. 24, 2001 (GB) 0117999.3

(51) Int. Cl. G02B 6/36

(52) U.S. Cl. 385/77

(57) ABSTRACT

A fiber block for connecting optical fibers to an optical device comprises a lithographically defined front face and a plurality of recesses for optical fibers extending linearly from the front face in a plane which is substantially perpendicular to the front face, at an angle within that plane which is non-perpendicular to the front face. It is preferred that the block is essentially rectangular with recesses for the optical fiber formed in it in a non-perpendicular arrangement. The block is preferably formed as two mating parts each with aligned recesses on their mating faces, thereby to permit an optical fiber to be held in a pair of recesses one on each part. The recesses can end with a locally narrower portion which acts as an end stop for the fiber thereby to permit it to be located accurately. The recesses are preferably V-grooves and the block is preferably of silicon. A method of forming a fiber block is also disclosed, consisting of the steps of lithographically defining at least one edge thereof, lithographically defining a recess for seating an optical fiber, the recess extending to the edge, wherein the recess subtends an angle at the edge which is non-perpendicular.

The present invention relates to the connection of optical fibres to optical devices.

In order to process an optical signal, it must be conveyed into an optical device. Even where there is no optical input, the output of the device must also be extracted and conveyed elsewhere. This is normally done by way of one or more optical fibres. These must therefore be connected to the device.

Where the device is an integrated optical device, the signal will often be guided by waveguides to an edge of the device for coupling to an optical fibre. Previous applications by ourselves have dealt with arrangements for this coupling, an example being GB0105838.1 filed on Mar. 9, 2001. A common factor is that the edge of the device must be at a non-perpendicular angle to the signal. If this is not so, back reflections from the interface can remain in the waveguide or fibre and reduce the signal/noise ratio. Provided the edge face is not perpendicular, back reflections will go elsewhere. They may cause problems as so-called “stray light” if they remain in the integrated device, but other arrangements can be put in place to reduce this.

Optical fibres are therefore brought to the edge face of the device in a “fibre block” that holds one or more fibres in a fixed orientation. The end of the block is typically polished to an angle in one plane, and the angled face is aligned with the edge face of the device. This polishing can be such that the fibres approach the device from out of the plane thereof, a so-called “type A” block. Alternatively, in a so-called “type B” block the end face of the block is polished so that the fibres approach the device in the same plane but not transversely to the edge. Within the blocks, the fibres are held in v-grooves formed by photolithography.

Type B blocks are preferred in principle since the planar nature of the device and block is easier to support. However, the polishing step must be at an angle to the block. Whilst the v-grooves can be located very precisely due to the photo-lithographic processes employed, the angle of the polishing step is subject to a tolerance of (typically) 0.2-0.5°. It will be apparent that as the number of fibres in the block increases, so will its width and thus the linear error resulting from a fixed angular error will increase. When this exceeds about 2 μm then the misalignment of the fibre and waveguide will be sufficient to render the block unusable.

The present invention therefore seeks to provide a fibre block in which this problem is alleviated.

The present invention therefore provides a fibre block for connecting optical fibres to an optical device, comprising a lithographically defined front face and a plurality of recesses for optical fibres extending linearly from the front face in a plane which is substantially perpendicular to the front face, at an angle within that plane which is non-perpendicular to the front face.

It is preferred that the block has side faces transverse to the front face. It is in general easiest to manufacture the block if these are substantially perpendicular to the front face, i.e. if the block is essentially rectangular with recesses for the optical fibre formed in it in a non-perpendicular arrangement. Thus, the side faces are also at an angle to the recesses.

The block is preferably formed as two mating parts each with aligned recesses on their mating faces, thereby to permit an optical fibre to be held in a pair of recesses one on each part.

The recesses preferably end with a locally narrower portion which acts as an end stop for the fibre thereby to permit it to be located accurately. However, it is also possible to place the fibres in the recess such that they overlap the front face and then cleave or otherwise shorten the fibres to the appropriate length.

The recesses are preferably V-grooves, since these are straightforward to form. The block is preferably of silicon as lithographic techniques for shaping silicon and forming V-grooves therein are widely available.

The invention also provides a method of forming a fibre block, consisting of the steps of lithographically defining at least one edge thereof, lithographically defining a recess for seating an optical fibre, the recess extending to the edge, wherein the recess subtends an angle at the edge which is non-perpendicular.

In a preferred arrangement, the edges of the block are defined by a dry etch.

Embodiments of the present invention will now be described by way of example, with reference to the accompanying figures, in which;

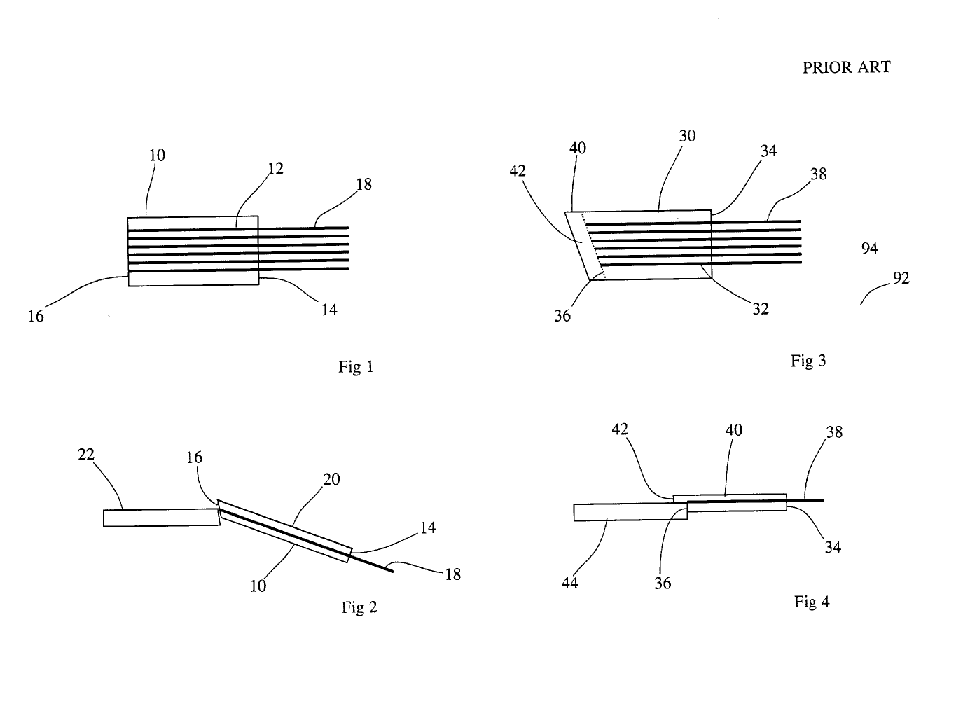

FIGS. 1 and 2 are plan and side sectional views respectively of a type A fibre block;

FIGS. 3 and 4 are plan and side sectional views respectively of a type B fibre block;

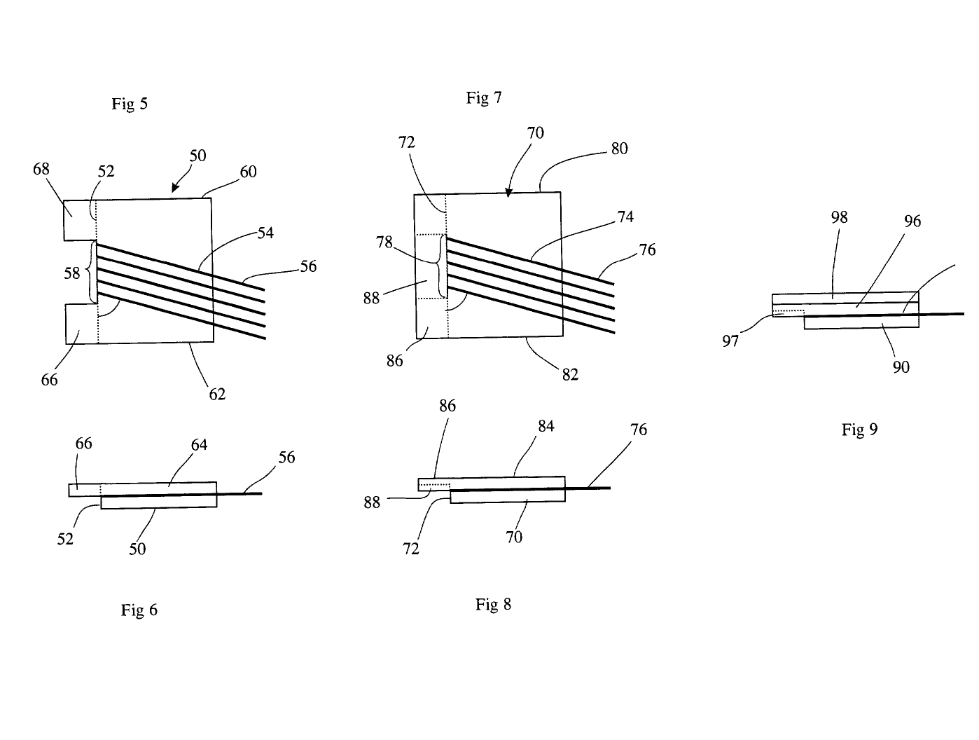

FIGS. 5 and 6 are plan and side sectional views respectively of a fibre block being a first embodiment of the present invention;

FIGS. 7 and 8 are plan and side sectional views respectively of a fibre block accordingly to a second embodiment of the present inventions;

FIG. 9 is a side sectional view of a fibre block according to a third embodiment of the present invention;

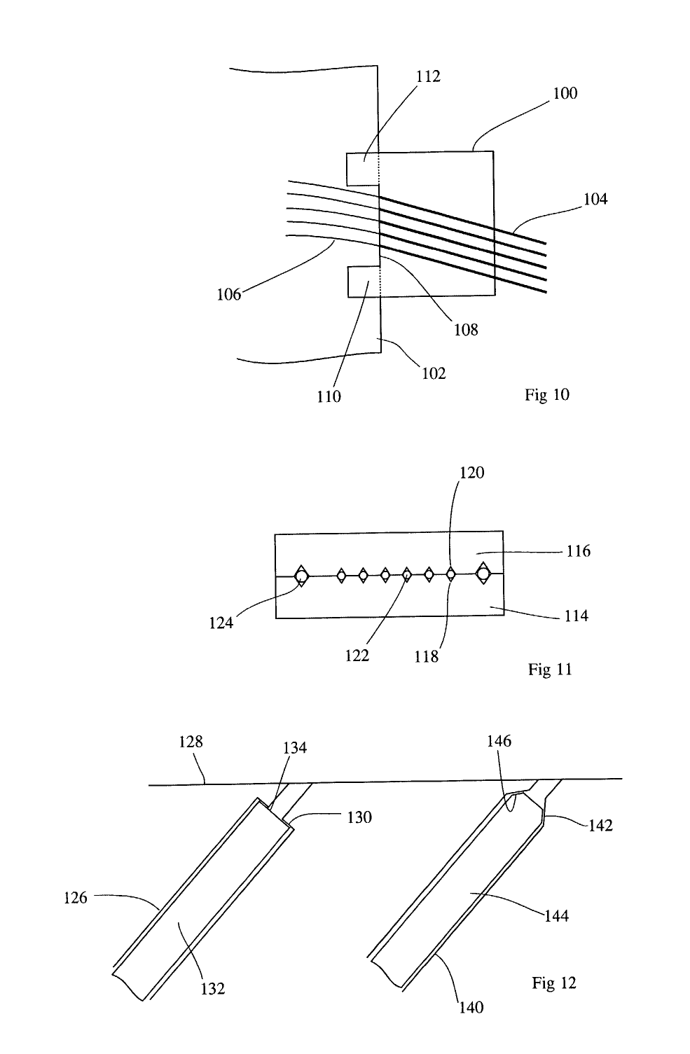

FIG. 10 is a plan view showing the fibre block according to the first aspect of the present invention in the place on an optical device;

FIG. 11 shows the V-grooves used in the present invention;

FIG. 12 shows suitable longitudinal profiles for the V-grooves according to the present invention.

FIGS. 1 and 2 show a known “type A” fibre block. A rectangular silicon block 10 has a number of parallel V-grooves 12 which run from a rear face 14 to a front face 16. Optical fibres 18 are placed in the grooves 12 and sandwiched therein by a further silicon block 20 which is placed over the block 10. The front face 16 is then polished so that it is at an angle to the top and bottom faces of the blocks 10, 20, and thus at an angle to the plane defined by the parallel row of fibres 18.

The fibre block is then aligned with an optical device 22 as shown in FIG. 2, such that the angled front face 16 is butt joined to an edge of the device 22. The fibres 18 thus approach the device 22 out of its plane, and transmission between the fibre and a waveguide in the device 22 is at a surface which is not transverse to the optical mode. However, maintaining the two parts at an unusual angle can present difficulties.

FIGS. 3 and 4 show a “type B” fibre block. A block 30 likewise has a number of V-grooves 32 formed therein, which again extend from the rear face 34 to a front face 36. Optical fibres 38 are placed in the V-grooves 32. However, in this case, front face 36 is polished to a plane which is transverse to the plane defined by the optical fibres 38 but is not perpendicular to the length of those fibres. The fibres are held in the V-groove by an upper block 40. In this case, the upper block 40 is slightly longer than the lower block 30 and thus overhangs. The front face 42 of the upper block 40 thus extends further forth than the front face 36 of the lower block 30. The front face 42 of the upper block 40 is however polished to the same angle.

When the fibre block is butt joined to an optical device 44, the upper block 40 can overlie the edge of the device 44 such that the front face 36 of the lower block 30 is smoothly aligned with the edge of the device 44. As the front faces 36, 42 are at an angle to the longitudinal direction of the fibres 38, coupling can then be achieved.

This type of fibre block is problematic to produce, since the spacing of the fibres as seen by the device 44 is a function of the angle at which the front face 36 is polished. Most of the features of the block can be defined accurately by a photo-lithographic methods, but this angle must be polished and there can be a small inaccuracy in the polishing angle. This will translate into an inaccuracy in the fibre spacing as seen by the device 44.

FIGS. 5 and 6 show a first embodiment of the invention. A fibre block 50 is generally rectangular and has a front edge 52. V-grooves 54 are again formed in the block 50 via known wet etch methods and fibres 56 are fixed in the grooves 54. The V-grooves 54 and the optical fibres within them terminate in a central area 58 of the front face 52.

The front face 52 is square with the remainder of the device, and thus perpendicular with the side walls 60, 62. It can therefore be formed using photo lithographic methods which offer suitable levels of accuracy. Dry etch methods are known which are suitable for use in doing so. In order to prevent the fibres terminating at a transverse potentially reflective face, the V-grooves 54 in which the fibres 56 are positioned extend back from the front face 52 at an acute angle α, where α≠90°. Thus, the V-grooves 54 do not extend back perpendicular to the front face 52.

A crystallographic plane will have to be chosen for the wet etch giving rise to the V-grooves, and therefore a dry etch is preferred for the outline of the block as this can be at substantially any angle. The dry etch may widen V-grooves in the vicinity thereof but this is unlikely to be problematic. If it is, then compensatory measures can be taken in the wet etch.

An upper block 64 is placed over the fibre block 50, and corresponding V-grooves are formed in the upper blocks 64 so that the circular section fibres 56 seat neatly within a pair of opposing grooves. The upper plate 64 extends as far as the front edge 52 of the lower block 50, except outside the central area 58 where it includes overhangs 66,68. In order to connect the fibre block to an optical device, these overhangs can rest on the upper surface of the device, in which case the end of the fibre 56 rests adjacent the edge of the device.

The fibres can be placed accurately in the block so that they end at the edge. Alternatively, they can be placed so that they overhang and then be cleaved to the appropriate length. Laser cleaving is especially suitable for doing so as it can also be used to lens or profile the cut ends of the fibres. In a further alternative, the fibres can be located accurately as described herein with reference to FIG. 12.

FIGS. 7 and 8 show an alternative embodiment. This is similar to the first, in that a lower block 70 has a front face 72 and V-grooves 74 in which fibres 76 are seated, extending back from a central area 78 of the front face at an angle α≠90°. Once again, this enables the front face 72 to be perpendicular to the side faces 80, 82 and, as a result, no polishing step is required and the front face 72 can be photolithographically defined. An upper block 84 is secured over the lower block 70, but in this embodiment (as opposed to the first), an overhang 86 extends along the entire length of the front face 72. However, over the central area 78, the lower surface of the overhang 86 is provided with a recess 88, extending from above the front face 72 of the lower block 70 to the front of the overhang 86. This essentially raises the underside of the overhang 86 over the central area 78 and accommodates the height of any surface features such as rib waveguides that are required to interface with the fibres 76.

FIG. 9 shows a third embodiment. This has a lower block 90, fibres 92 seated in v-grooves 94, and an upper block 96 with corresponding v-grooves so as to retain the fibres in place. An overhang 97 is provided, as with the second embodiment. In addition, a superstrate 98 is provided over the upper block 96 to provided additional rigidity and strength. This can be of any suitable material such as glass, a ceramic, quartz etc. As shown in FIG. 9, the superstrate covers the entire area of the upper block 96 including the overhang 97, although if desired it could cover a lesser area. Most benefit is likely to be obtained if the superstrate covers the overhang 97 and at least part of the upper block 96 immediately behind it.

FIG. 10 shows a fibre block 100 according to the invention in place on a device 102. Fibres 104 are held by the block 100 in place at an angle to the device 102 but in the same plane. Rib waveguides 106 on the device 102 approach the block 100 and meet its edge in the central region 108. Overhangs 110, 112 rest on the top surface of the device on either side of the central area 108 and thus do not interfere with the rib waveguides 106 but nevertheless allow the block 100 to be secured in place,

FIG. 11 shows a section through a block according to the invention. A lower block 114 and an upper block 116 have v-grooves 118, 120 respectively in corresponding locations. Fibres 122 are sandwiched between the upper and lower blocks 116, 114 in a matched pair of v-grooves 120, 118. A circular section fibre fits well into the diamond defined (in section) by a pair of v-grooves, which are themselves easy to form in a silicon substrate. Of course, the fibres need not be secured in a matched pair of grooves; a single deep groove could be formed.

Outside the area occupied by the fibres, a pit 124 is formed in a corresponding location on each block, 114,116. When the blocks are assembled, a sphere or bearing can be incorporated in the matched pair of pits to locate the blocks together. Two such locating pits 124 are visible in FIG. 11 and will of themselves be sufficient to uniquely position the pair of blocks 114, 116 although more could be provided for security, or less if an alternative locator was present. It will be appreciated that the front face, v-grooves and locator pits can all be defined photolithographically and thus benefit from the high positional accuracy available thereby. As a result, on the macro scale the block as a whole can be fabricated with a high precision.

FIG. 12 shows how the v-grooves can be terminated. One option, not shown in FIG. 12, is to bring the grooves to the edge of the block and allow the fibres (initially) to overhang. They can then be planed off after assembly by (for example) a laser cleaver. As shown in FIG. 12, the groove can be terminated at the edge with a locating feature that will allow the fibres to be positioned close to but not at the edge of the device, thus protecting them during subsequent assembly steps. Two possibilities are shown in FIG. 12. A first groove 126 has a step 130 formed close to the edge 128, such that its width reduces abruptly. The groove itself can continue to allow transmission of the optical signal, although depending on the material of the block the signal could be transmitted therethrough in which case the width could in essence be reduced to zero. Thus, a fibre 132 in the groove can be located accurately with its end face 134 against the step 130.

A second v-groove 140 shown in FIG. 12 is also formed with a step 142 but in this case the reduction in width is linear instead of abrupt. A fibre 144 with a end 146 which is polished to match is placed in the v-groove 140 and locates in a similar manner.

These arrangements can be achieved by wet etching the V-groove to a point which stops short of the edge (or the intended position of the edge). This will in all likelihood leave a V-profile to the end of the V-groove. A dry etch can then be performed to complete the profile of the groove to that required.

It will thus be appreciated that a fibre block can be formed according to the present invention with improved tolerances. Thus, the advantages of both type A and B blocks described above can be obtained, allowing larger numbers of accurately located fibres to be brought to the edge of a device in the plane thereof. It will also be appreciated that the above-described embodiments are merely examples of fibre blocks falling within the scope of the present invention and that variations may be made thereto to suit individual design requirements.

1. A fibre block for connecting optical fibres to an optical device, comprising a lithographically defined front face and a plurality of recesses for optical fibres extending linearly from the front face in a plane which is substantially perpendicular to the front face, at an angle within that plane which is non-perpendicular to the front face.

2. A fibre block according to claim 1 in which the block has side faces transverse to the front face.

3. A fibre block according to claim 2 in which the side faces are substantially perpendicular to the front face.

4. A fibre block according to any one of the preceding claims being essentially rectangular with recesses for the optical fibre formed therein non-perpendicularly to the edges thereof.

5. A fibre block according to any one of the preceding claims formed as two mating parts each with aligned recesses on their mating faces, thereby to permit an optical fibre to be held in a pair of recesses one on each part.

6. A fibre block according to any one of the preceding claims in which the recesses end with a locally narrower portion.

7. A fibre block according to any one of the preceding claims in which the recesses are V-grooves.

8. A fibre block according to any one of the preceding claims formed of silicon.

9. A fibre block substantially as herein described with reference to and/or as illustrated in the accompanying figures.

10. A method of forming a fibre block, consisting of the steps of lithographically defining at least one edge thereof, lithographically defining a recess for seating an optical fibre, the recess extending to the edge, wherein the recess subtends an angle at the edge which is non-perpendicular.

11. A method according to claim 10 in which the edge of the block is defined by a dry etch.

12. A fibre block according to claim 10 or claim 11 in which the recesses end with a locally narrower portion.

13. A fibre block according to claim 12 in which the locally narrower portion is defined by a combination of a wet and a dry etch.

14. A method of forming a fibre block substantially as herein described with reference to and/or as illustrated in the accompanying figures.
